(19) United States
(12) Patent Application Publication
(10) Pub. No.: US 2008/0029445 A1
(43) Pub. Date: Feb. 7, 2008

(54) SORTING SYSTEM

(75) Inventors: David L. Russcher, Zeeland, MI (US); Robert J. Herweyer, Fennville, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: LOUIS PADNOS IRON AND METAL COMPANY, Holland, MI (US)

(21) Appl. No.: 11/462,168

(22) Filed: Aug. 3, 2006

(51) Int. Cl. B07C 9/00

(52) U.S. Cl. 209/657; 209/552

(57) ABSTRACT

A sorting system for separating metals from nonmetals in an automobile recycling process. The system includes a belt conveyor, a sensor assembly under the conveyor, a deflector assembly at the end of the conveyor, and a microprocessor for controlling the deflector assembly in response to the sensor assembly. The sensor assembly includes a plurality of sensors arranged transversely across the conveyor and each capable of detecting metal. The microprocessor generates selectively actuates fingers in the deflector assembly to deflect the metals from the material stream.

### BACKGROUND OF THE INVENTION

The present invention relates to scrap sorting systems, and more particularly to such systems used in the recycling of automobiles.

All kinds of materials are used in manufacturing automobiles. These materials include ferrous metals (e.g. iron and steel), nonferrous metals (e.g. stainless steel, aluminum, and copper), and everything else (e.g. plastic, rubber, insulation, carpet, leather, and cloth). This conglomeration of materials presents an interesting challenge in the recycling process—namely separating the constituent materials as completely as possible for subsequent resale. There is a balance to be struck between extracting the maximum amount of salvage materials (e.g. metals) and making the separated materials as “clean” as possible (i.e. free from other “contaminating” materials). Improved separation of the materials results in scrap that is more useful and therefore has higher value. Therefore, there is a constant desire for improved materials separation.

In the automobile recycling process, the automobiles are first shredded. The shredded scrap is sorted into three general categories—ferrous metal, non-ferrous metal, and automobile shredder residue (ASR) which includes everything else. The techniques for making these basic separations are well known. Electro-magnets first are used to separate out the ferrous scrap metal. An eddy current separator is then used to separate out the non-ferrous scrap metal. The remaining ASR however still contains some residual metals—both ferrous and non-ferrous—in sufficient quantities to expend further effort in their additional separation.

In current systems for continued processing of the ASR, compressed air is used to remove the residual metals from the ASR. More specifically, the ASR travels along a conveyor over metal-detecting sensors. A control system is responsive to the sensors and actuates compressed air jets to “blow” the metals from the ASR stream. The volume and pressure of the compressed air required to make the separation is significant. This results in at least three problems. First, the compressed air propels large amounts of dust into the surrounding environment. Second, relatively heavy duty compressed air systems (e.g. compressors) are required, which increases capital cost, operating cost, and complexity. Third, the speed at which the conveyor is operated is limited by the operating time of the compressed air separation.

### SUMMARY OF THE INVENTION

The aforementioned problems are overcome by the present invention comprising an improved sorting conveyor system for removing residual metal from the ASR stream which (1) reduces dust and cost and (2) improves speed and accuracy. The sorting conveyor system includes a conveyor, at least one metal-detecting sensor below the conveyor, a controllable deflector assembly at the end of the conveyor, and a control system for selectively actuating the deflector assembly in response to signals from the sensors. As the ASR travels along the conveyor, the sensor detects metals, and the control system selectively actuates the deflector assembly to selectively deflect the path of the metals as they falls off the end of the conveyor.

The deflector assembly includes one or more deflectors and an actuator for each deflector. In the described embodiment, the deflectors are pneumatic cylinders that shift each deflector between a retracted position and an extended position. In the retracted position, the deflector is withdrawn from the natural path or trajectory of material falling off the end of the conveyor. In the extended position, the deflector extends into the trajectory of the material to deflect the metals from their natural path.

The present invention results in several distinct advantages. First, because the invention eliminates the use of compressed air to move material, it greatly reduces the amount of dust generated during the sorting process. Second, the relatively small volume and pressure of the compressed air required to actuate the deflector assembly enables a smaller compressor to be used, reducing both capital cost and operating cost. Third, the deflector assembly enables the conveyor to be operated at a higher speed, resulting in increased throughput and efficiency.

These and other objects, advantages, and features of the invention will be more fully understood and appreciated by reference to the description of the current embodiment and the drawings.

### BRIEF DESCRIPTION OF THE DRAWINGS

FIG. 1 is a schematic illustration of a multi-step scrap processing system that includes the sorting system of the present invention.

FIG. 2 is a perspective view of the sorting system of the present invention.

FIG. 3 is a top plan view of the sorting system.

FIG. 4 is a side elevational view of the sorting system showing all of deflector fingers in their retracted position.

FIG. 5 is a side elevational view of the sorting system showing selected ones of the deflector fingers in their extended position.

### DESCRIPTION OF THE CURRENT EMBODIMENT

### I. General Description of the Sorting System

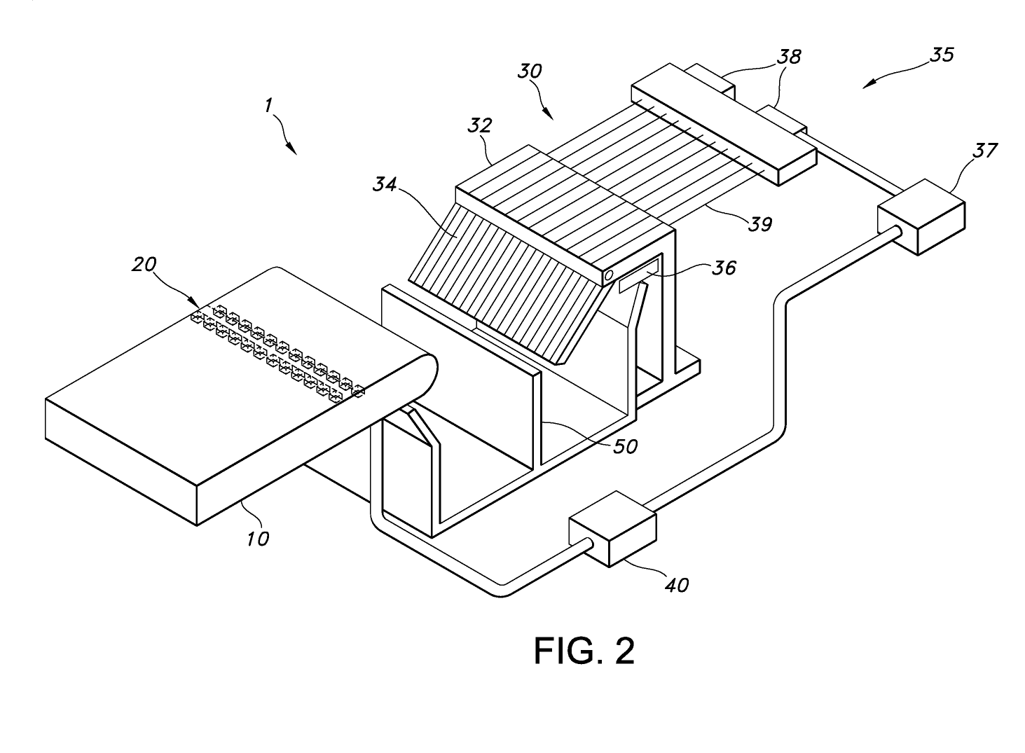

A sorting system constructed in accordance with the current embodiment of the invention is illustrated in FIGS. 2-5 and generally designated 1. The sorting system 1 includes a conveyor 10, a sensor assembly 20, a deflector assembly 30, and a microprocessor 40. The conveyor 10 transports ASR including non-metal material 22 and metal material 24 within range of the sensor assembly 20 which detects the presence of pieces of the metal material 24. The microprocessor 40 processes the signals from the sensor assembly 20 and controls actuation of the deflector assembly 30. The deflector assembly 30 selectively alters the path or trajectory of the metal material 24 as it falls off the end of the conveyor 10 to separate the metals from the reminder of the ASR. two or more groups.

### II. Detailed Description of the Sorting System

As noted above, the deflector sorting system 1 generally includes a conveyor 10, a sensor assembly 20, a deflector assembly 30, and a microprocessor 40. Optionally the sorting system may include a divider 50 or other appropriate storage structure to maintain the separation of the separated materials. In the illustrated embodiment, the system 1 separates metal 24 from non-metal 22. The sorting system may be used to sort a wide variety of material streams into two or more types of material 22, 24.

A. Conveyor

The conveyor 10 is used to transport material along a path toward the deflector assembly 30. The use of a conveyor 10 to transport material is well known to those skilled in the art and therefore will not be discussed in detail. In the current embodiment, the conveyor is a belt conveyor, but any suitable conveyor may be used. The speed of the conveyor 10 may vary from application to application, in the described embodiment the conveyor 10 travels in the general range of 250 to 550 feet per minute (FPM).

B. Sensor Assembly

The sensor assembly 20 in the current embodiment includes a plurality of sensors arranged along the width of the conveyor 10. Typically, one sensor is provided for each finger in the deflector assembly 30. Sensors for detecting metals or other specific materials are well known to those skilled in the art and therefore will not be discussed in detail. In the described embodiment, the sensor assembly 20 includes twenty-four inductive proximity sensors (Model No. 871L-B40E40-T2) available from Allen-Bradley for detecting the presence of metal. Additional, different, or fewer sensors may be used which detect the same or different material properties.

The sensor assembly 20 is mounted in any suitable position upstream of the deflector assembly 30. In the described embodiment, the sensor assembly 20 is mounted inside the conveyor 10 and under the top surface of the belt.

The sensor assembly 20 is in communication with the microprocessor 40. A metal detection or other signal is generated by each sensor in the sensor assembly 20 in response to a metal object passing over the sensor. The signal is sent to the microprocessor 40.

C. Deflector Assembly

The deflector assembly 30 includes a support structure 32, one or more deflectors or fingers 34, and an actuator assembly 35 including an actuator for each deflector. The deflectors 34 are pivotally mounted on the support structure 32. The deflector assembly support structure 32 may be free standing or integrally formed with additional structure (not shown) to support additional components in the deflector sorting system 1.

The deflectors 34 may be any suitable structure capable of deflecting the material. In the described embodiment, the deflectors 34 are fabricated of ultra high molecular weight (UHMW) material, but any other suitable wear-resistant material may be used. The deflectors 34 currently are hingedly mounted to the support structure 32, but the deflectors 34 may be slidably or otherwise movably mounted to the support structure 32.

The actuator assembly 35 may use any suitable components to actuate the deflectors 34 between at least two different positions. The actuator assembly 35 in the described embodiment includes a pneumatic actuator or cylinder 36 for each finger and a compressor 37. In alternative embodiments, the actuator assembly 35 may include additional, different, or fewer components. For example, in one alternative embodiment, the actuator assembly 35 may include electric or hydraulic actuators with approriate power and control components. Other actuator assemblies known to those skilled in the art may be substituted for the acutator assembly 35 of the current embodiment.

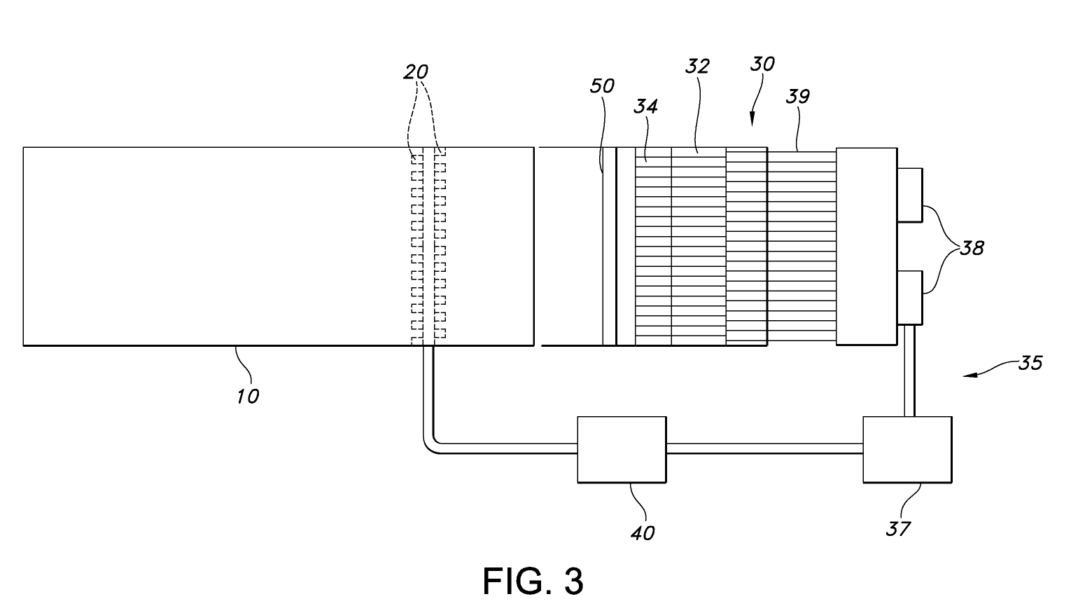

A plurailty of solenoid valves 38 (FIGS. 2-3) are controlled by the microprocessor 40 and route air from the compressor 37 to the individual actuators 36 through the hoses 39. Although only two valves 38 are illustrated, a pair of valves is provided for each double-action pneumatic cylinder for each finger. The air enables the deflectors 34 to toggle or otherwise move between a retracted position and an extended position.

D. Microprocessor

The microprocessor 40 communicates with the sensor assembly 20 and the deflector assembly 30. The microprocessor 40 may be electrically or wirelessly connected or integrally formed with the sensor assembly 20 or deflector assembly 30. The microprocessor 40 receives signals from the sensor assembly 20 and controls the deflector assembly 30 based on the signals.

Selective extension and retraction of each deflector 34 depends on whether a corresponding sensor in the sensor assembly 20 generates a metal detection signal. Put another way, in the current embodiment, there is a one-to-one correspondence between the number of sensors in the sensor assembly 20 and the number of deflectors 34. In alternative embodiments, there may be a one-to-many or many-to-one correspondence between the sensors in the sensor assembly 20 and the deflectors 34.

E. Divider

A divider 50 may be provided to maintain the separation of the deflected and non-deflected material, and to thereby reduce cross contamination between the two groups of material. In the illustrated embodiment, the divider 50 is a vertical wall, however the divider 50 may be any suitable structure for dividing the material into two or more groups. For example, in alternative embodiments the divider may be two or more chutes, two or more bins, or any other suitable storage structure.

### III. Incorporation of the Sorting System into a Scrap Processing System

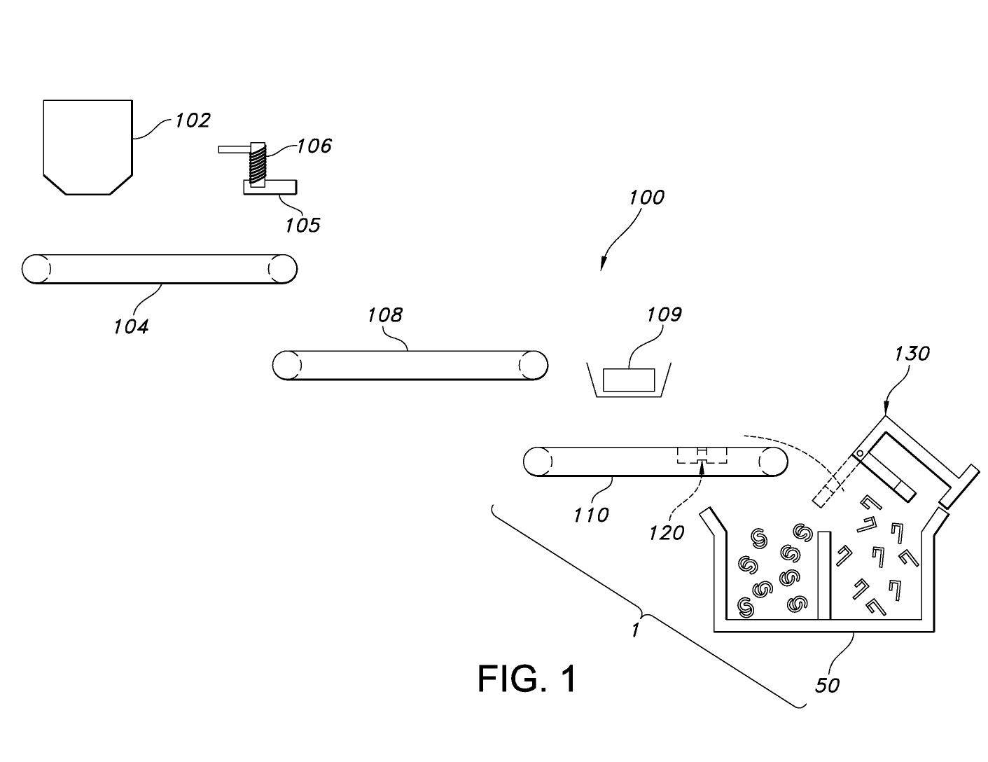

The deflector sorting system 1 may be included in a larger recycling system. For example, as shown in FIG. 1, the deflector sorting system 1 may be used to extract additional metal from ASR produced in an automobile scrap sorting system 100. Shredded automobile scrap is fed onto the conveyor 104 from the bin 102. An electro-magnet 106 separates ferrous metal 105 from the scrap. Other methods known in the art may be used to separate the ferrous metal 105. The remaining scrap falls onto a conveyor 108. Eddy current separators (not shown) separate the non-ferrous metal 109 from the scrap leaving the remaining material, automobile shredder residue (ASR), to pass into the sorting system 1 of the present invention.

The ASR travels along the conveyor 110 where a sensor assembly 120 detects any remaining or residual metal pieces not separated in the previous steps. The sensors communicate with the deflector assembly 130 via a microprocessor 140. The individual fingers of the deflector assembly 130 are selectively actuated to deflect or alter the trajectory of detected metal onto one side of the divider 50 as it falls off the conveyor 110. The nonmetallic portion of the ASR follows its natural path or trajectory off the conveyor 110 onto a different side of the divider 50.

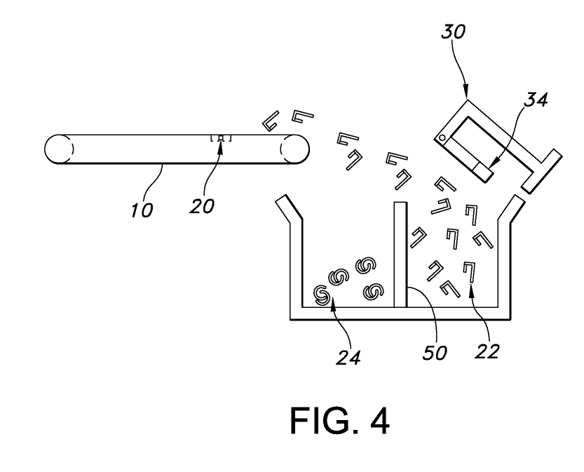

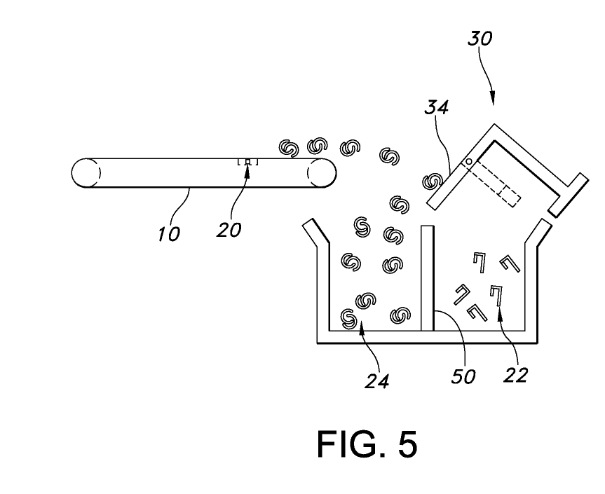

Specifically, the actuator assembly 35 actuates one or more deflectors 34 in response to the microprocessor 40. A single finger may be actuated for small metal pieces, and multiple fingers may be actuated for larger pieces. As discussed above, the deflector 34 may be actuated between extended and retracted positions. In the retracted position, as shown in FIG. 4, the deflector 34 does not interfere with the natural path or trajectory of material 22 falling off the edge of the conveyor 10 onto one side of the divider 50. In the extended position, as shown in FIG. 5, the deflector 34 enters the natural path or trajectory of the material to deflect the metal 24 onto a different side of the divider 50. Depending on which deflectors 34 are extended and which are retracted, material at different transverse or lateral positions may be traveling onto both sides of the divider 50 at the same time.

Although the sorting system of the present invention has been described in conjunction with a recycling process for separating metals from nonmetals, it will be recognized that the invention is extendible to a variety of applications in which one admixed material is to separated from another. Also, while the current system is configured to deflect metals from the material stream, it will be recognized that the system can be configured to deflect nonmetals from the material stream.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A sorting system for separating metal material from non-metal material comprising:
a conveyor adapted to transport the materials and having an exit end from which the transported material follows a trajectory;
a plurality of sensors arranged transversely with respect to said conveyor and each adapted to detect metal material on said conveyor and generating a detection signal in response thereto;
a mechanical deflection assembly at said exit end of said conveyor, said deflection assembly including a plurality of fingers each associated with one of said sensors, at least selected ones of said finger being independently actuable between an extended position in the trajectory and a retracted position out of the trajectory; and
a control means for controlling said fingers in response to signals received from said sensors to extend said fingers into the trajectory of the metal material and to retract said fingers from the trajectory of the nonmetal material.

2. The sorting system of claim 1 wherein each of said sensors is associated with exactly one of said fingers.

3. The sorting system of claim 1 wherein said deflection assembly further includes an actuator associated with each of said fingers.

4. The sorting system of claim 3 wherein each of said actuators comprise a pneumatic actuator.

5. A sorting system for separating a first material from a second material comprising:
a conveyor adapted to transport the first and second materials and having an exit end from which the transported materials follow a trajectory;
a plurality of sensors arranged transversely with respect to said conveyor and each adapted to detect the presence of the first material on said conveyor and generating a detection signal in response thereto;
a mechanical deflection assembly at said exit end of said conveyor, said deflection assembly including a plurality of fingers each associated with one of said sensors, each finger being actuable between an extended position in the trajectory and a retracted position out of the trajectory; and
a control means for controlling said fingers in response to signals received from said sensors to extend said fingers into the trajectory of the metal material and to retract said fingers from the trajectory of the nonmetal material.

6. The sorting system of claim 5 further comprising a pneumatic actuator associated with each of said fingers.

7. A method of separating a first material from a second material comprising:
transporting the first and second material along a path and then allowing the first and second material to follow a trajectory from said path;
sensing the presence of the first material along the path;
activating a mechanical deflector into the trajectory in response to the presence of the first material and out of the trajectory in the in response to the absence of the present of the first material, whereby the first material is deflected from the trajectory and the second material follows the trajectory.

8. The method of claim 7 further comprising storing the first material on one side of a divider and storing the second material on another side of the divider.

9. The method of claim 7 wherein said activating step includes pneumatic actuation.

10. The method of claim 7 wherein the first material is metal and the second material is non-metal.

11. The method of claim 7 wherein said activating step includes using a microprocessor.
